(19) United States
(12) Patent Application Publication
(10) Pub. No.: US 2026/0274160 A1
(43) Pub. Date: Sep. 17, 2026

(54) ILLUMINATED SEAT BELT BUCKLE FOR A SEAT BELT DEVICE OF A MOTOR VEHICLE

(71) Applicant: Autoliv Development AB, Vargarda (SE)

(72) Inventors: Michel HERMANN, Pinneberg (DE); Timo NEHRENHEIM, Hamburg (DE); Iulian ROTARIU, Kölln-Reisiek (DE); Leif SCHATTAUER, Elmshorn (DE)

(21) Appl. No.: 19/167,713

(22) PCT Filed: Mar. 21, 2024
(86) PCT No.: PCT/EP2024/057653

§ 371 Date: Sep. 22, 2025

(30) Foreign Application Priority Data
Mar. 22, 2023 (DE) 102023107196.3

(51) Int. Cl. B60Q 3/242; B60Q 3/60; B60R 22/18; F21V 3/00; F21W 106/00; F21Y 105/18

(52) U.S. Cl. CPC B60Q 3/242; B60R 22/18; B60R 2022/1806; F21W 2106/00

(57) ABSTRACT

An illuminated seat belt buckle for a seat belt device of a motor vehicle, having a housing, a push button which can be moved in the housing, an insertion slot for inserting a latch plate which can be locked in the seat belt buckle, and at least one annular light source which comprises the insertion slot and the push button, and a cover element which covers the annular light source towards the radial outer side and towards the end face of the seat belt buckle, wherein the cover element is integrally made of a translucent material.

The present invention relates to an illuminated belt buckle for a seat belt device of a motor vehicle, having the features of the preamble of claim 1.

Belt buckles for seat belt devices of motor vehicles serve in general to securely lock to a vehicle a latch plate movably guided on a belt webbing or securely connected to an end of a belt webbing. For this purpose, the belt buckle has an insertion slot for the latch plate and a locking mechanism which can be released via a push button. The locking mechanism is spring-loaded and automatically locks the latch plate upon insertion into the insertion slot. To release the latch plate, a passenger buckled up with the seat belt presses down the push button, whereby the locking mechanism is released and the latch plate is ejected by a released spring force of the locking mechanism.

Such seat belt buckles have been prior art for many years. A problem of such seat belt buckles is that to buckle up the occupant has to find the comparatively narrow insertion slot of the seat belt buckle into which he inserts the latch plate for fastening the seat belt.

It is known from DE 39 04 125 A1 to provide a belt lock with a light source, wherein the light source is coupled to predetermined light-emitting surfaces of the seat belt buckle via a light-conducting material. The light-emitting surfaces in this case are the push button itself and/or a radiating surface arranged on a side face of the insertion slot opposite the push button. Since the push button must be designed to be displaceable for its function, the light-conducting material fixedly arranged in the push button must be positioned in the push button in such a way that the light-entry surface of the light-conducting material is photometrically connected to the external light source when the push button is in the non-pressed position. If the light-entry surface of the light-conducting material in this position is not photometrically connected to the external light source due to production-related shape and position deviations or mechanical influences, the light will not or not completely be introduced into the push button so that the push button itself does not illuminate or illuminates more weakly than desired.

It is further known from DE 10 2007 047 704 A1 to provide a light conductor in the belt buckle, which light conductor has at least two light-emitting surfaces which are arranged at the ends of the insertion slot. The light-emitting surfaces themselves are triangular in shape and arranged in a free triangular area of the end face of the housing between the edge of the housing and a conical side face of the push button. The light-emitting surfaces are dimensioned in particular in such a way that they fill out the free areas in the corners of the end face of the housing as extensively as possible in order to achieve the best possible luminosity.

From U.S. Pat. No. 5,892,436 A an illuminated seat belt buckle is known in which a light source is connected via a plurality of light conductors, wherein the light conductors emerge at an end face of the housing and therefore form a plurality of luminous points which are arranged circumferentially around the push button of the seat belt buckle or around the insertion slot. However, this solution is complex and expensive; moreover, the light conductors lie in the direction of movement of the push button so that there is a risk of damage to the light conductors when the push button is operated to open the seat belt buckle.

From document DE 10 2015 215 254B4, an illuminated seat belt buckle is known in which the light-emitting surface is formed by a circumferential surface light source on the end face of the housing, wherein the surface light source is designed as a luminous thin-film component. An additional ring element is provided on the end face of the housing, which covers the surface light source on the end face of the seat belt buckle and on the radial outside of the seat belt buckle and therefore protects it from damage. The ring element is manufactured using a two-component injection-molding process and has a translucent region on the end face in the form of a continuous circumferential band and an opaque region on its radial outer side so that the seat belt buckle is intentionally illuminated only on the end face.

The object of the invention is to provide an inexpensive seat belt buckle of the generic type with improved lighting, in which the insertion slot and the push button for fastening and unfastening are particularly easy to find.

In order to achieve the object, an illuminated belt buckle with the features of claim 1 is proposed. Further preferred embodiments of the invention can be found in the dependent claims, the figures and the associated description.

According to claim 1, an illuminated seat belt buckle for a seat belt device of a motor vehicle is proposed, comprising a housing, a push button which can be moved in the housing, an insertion slot for the insertion of a latch plate which can be locked in the seat belt buckle, and at least one annular light source which comprises the insertion slot and the push button, and a cover element which covers the annular light source towards the radial outer side and towards the end face of the seat belt buckle, wherein the cover element is integrally made of a translucent material.

The proposed solution has the advantage that the light is emitted via the cover element not only towards the end face of the seat belt buckle but also radially towards the outside, wherein this is made possible solely by the one-piece design of the cover element and its translucent design. This makes the proposed solution particularly cost-effective while simultaneously improving the illumination of the seat belt buckle.

It is further proposed that the cover element has an integrally formed fastening attachment by means of which it is fastened to the housing of the seat belt buckle. This makes the attachment of the cover element and the associated assembly process particularly simple and cost-effective. To fasten the cover element, a corresponding fastening surface is provided on the housing of the seat belt buckle, which makes it possible for the cover element to be fastened via its fastening attachment.

It is further proposed that the fastening attachment has a latching hook with which it is latched into an undercut of the housing. A locking mechanism is advantageous because it can be carried out very easily during installation and does not require any additional fastening means.

It is further proposed that the housing has a closed annular section comprising the insertion slot and the push button, which section delimits an annular cavity towards the radial inner face, the annular cavity being delimited by the cover element towards the radial outer face and towards the end face of the seat belt buckle, and the light source being arranged in the annular cavity. The cover element thus encloses a cavity in the housing in which the light source is arranged. Since the cover element is translucent while the housing of the seat belt buckle is otherwise opaque, this ensures that all of the light emitted by the light source exits to the outside exclusively through the cover element. This means that the illumination of the seat belt buckle is defined exclusively by the cover element. In this context, on the one hand the shape of the cover element and on the other hand its translucent properties can be specifically designed to achieve high-quality visual illumination of the seat belt buckle.

In this regard, it is proposed that the cover element preferably abuts the annular section of the housing in the region of the end face of the seat belt buckle so that further parts are not required to form the cavity.

It is further proposed that the annular section projects from a base surface of the housing, and the cover element radially outwardly abuts a section of the housing forming the base surface. The cavity is therefore formed by the cover element, the annular section and the base surface, wherein the annular section and the base surface are part of the housing and form the inner wall of the cavity, and the cover element covers the cavity towards the outside.

It is further proposed that the light source is of annular design and is arranged on the base surface radially outward to the annular section of the housing. The proposed annular design of the light source and its arrangement on the base surface allows the cavity and therefore the cover element to be illuminated particularly evenly.

It is further proposed that the cover element has an integrally formed light-conducting section which has a light-entry surface arranged parallel and opposite to a light-emitting surface of the light source. Due to the integrally formed light-conducting section with the proposed arrangement of its light-entry surface, the light emitted by the light source is coupled into the cover element with an improved yield, wherein the light conductor specifically creates a light-conducting connection of the light-entry surface to the radially outer radiating surface of the cover element.

It is further proposed that a gap is provided between the integrally formed light-conducting section and a radially outer edge of the cover element. Through the gap, the cover element can with its outer edge perform slight spring movements towards the light-conducting section, which can be used to fasten the cover element during assembly. This is in particular advantageous because the light-conducting section in principle stiffens the cover element due to its volume, which is compensated for by the spring elasticity of the edge of the cover element created by the gap.

It is further proposed that the light source is formed by an annular light conductor which abuts the radial outer face of the annular section and has a light-exit surface. The annular light conductor forms a light source with its light-exit surface, wherein the light-exit geometry is defined by the light-exit surface created thereon. To feed in the light itself, the light conductor is connected to an external light source which can be arranged either in the housing of the seat belt buckle or in the cavity or at any external location at which the light is coupled into the light conductor.

In this regard, the light conductor is preferably designed to be partially circular in cross-section, wherein the light emerges from the light conductor not only towards the radial outside of the seat belt buckle but also towards the end face of the seat belt buckle. This illuminates the cavity between the cover element and the annular section or the cover element radially outwards and in the direction of the end face of the seat belt buckle.

It is further proposed that the cover element is arranged with no contact with the light source. The contactless arrangement of the light source relative to the cover element prevents the light source from being exposed to mechanical stress during attachment of the cover element. Furthermore, the contactless arrangement of the cover element is advantageous for a homogeneous illumination of the cover element since the light emitted by the light source is additionally distributed before entering the cover element.

It is further proposed that the cover element has a first section which extends in the direction of an end face of the seat belt buckle, and the cover element has a second section which extends on the end face of the seat belt buckle in the direction of the push button and the insertion slot. The cover element is therefore structurally divided into two sections, wherein the first section is arranged in the direction of the end face of the seat belt buckle and therefore forms the radial outer side of the cover element, while the second section extends in the direction of the push button and the insertion slot and is therefore arranged on the end face of the seat belt buckle.

It is further proposed that the second section has a greater thickness than the first section. The first section serves to radiate the light laterally through the cover element, while the second section is provided to radiate the light at the end face of the seat belt buckle which is preferably facing the viewer. In this case, the greater thickness of the second section is advantageous in that it scatters the light more in the second section than in the first section, which results in the viewer perceiving the seat belt buckle as being more evenly illuminated overall.

It is further proposed that a marking, preferably an information symbol, be provided on the first section and/or the second section. Markings or information symbols can include company logos, warning signs or simply aesthetic motifs. Overall, the cover element can also have a second function as an information carrier or as a decorative element, and therefore further increases the value of the seat belt buckle.

It is further proposed that the cover element has a different surface finish on the outside of the first section than on the outside of the second portion. Due to the different surface properties of the cover element in the two sections, the cover element can be designed differently in terms of feel and appearance on its end face in the region of the seat belt buckle than in the first section on the radial outer side. This allows the seat belt buckle to be customized to the individual customer, both in terms of appearance as well as feel.

It is further proposed that the cover element in the region of the first section be locally opaque due to a coating, printing or surface treatment. This deliberately locally realized opacity can be used by an appropriate shaping to achieve an improved visual appearance or to intentionally display symbols or characters upon activation of the light source.

The invention is explained below using preferred embodiments with reference to the accompanying figures. In the figures:

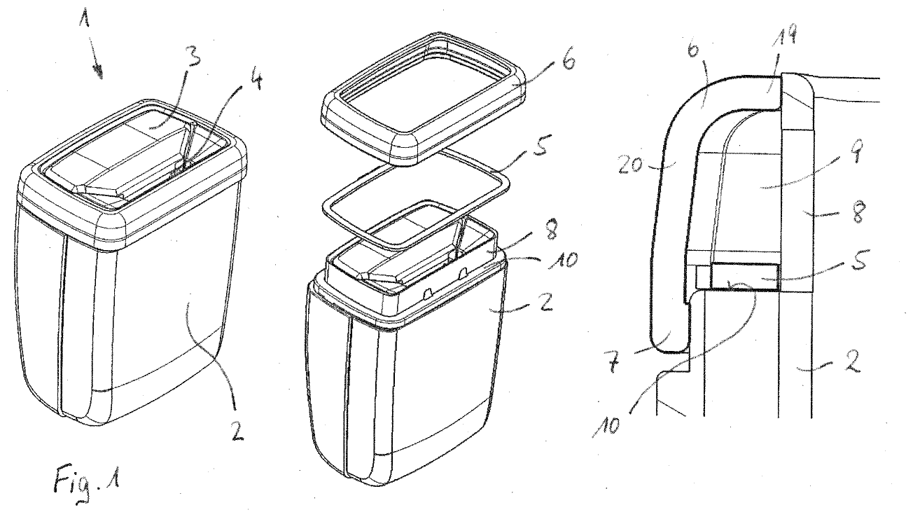

FIG. 1 shows a seat belt buckle according to the invention according to a first embodiment; and

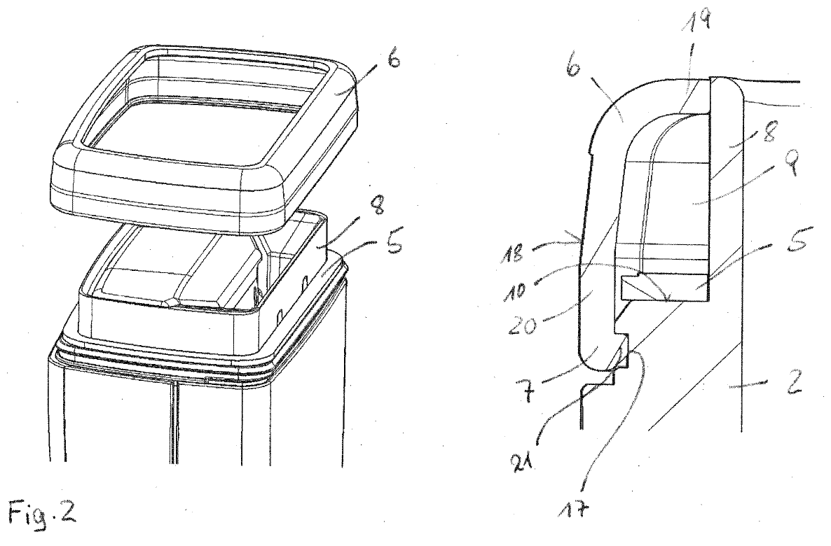

FIG. 2 shows the seat belt buckle according to the invention in FIG. 1 in a preferred further development; and

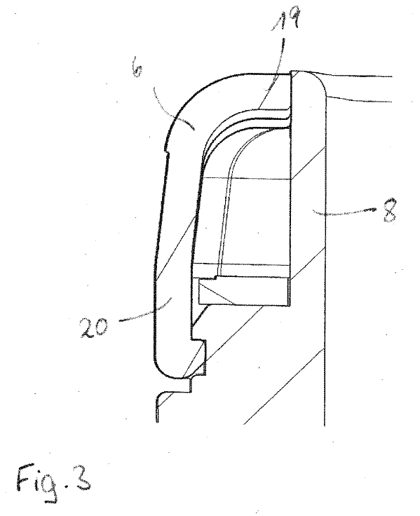

FIG. 3 shows the seat belt buckle according to the invention in FIG. 1 with a cover element of different thicknesses; and

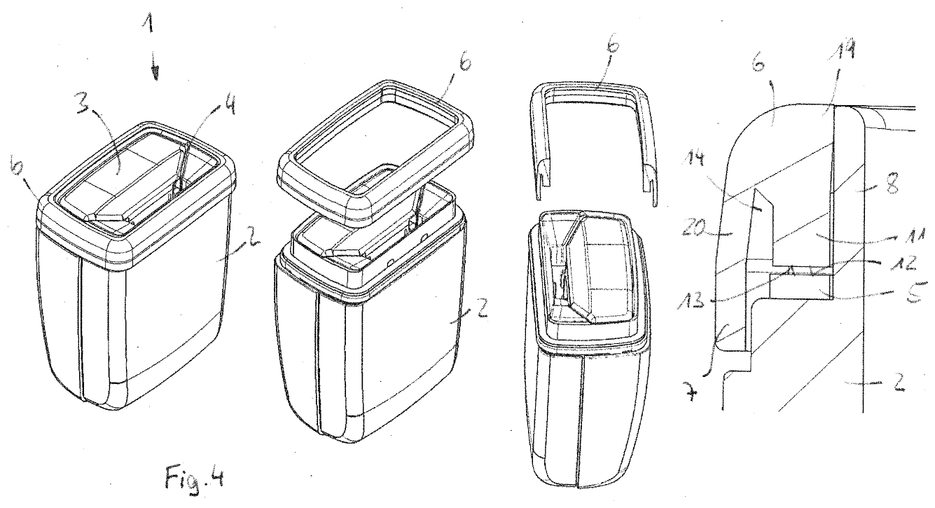

FIG. 4 shows a seat belt buckle according to the invention with a cover element with an integrated light conductor according to a second embodiment; and

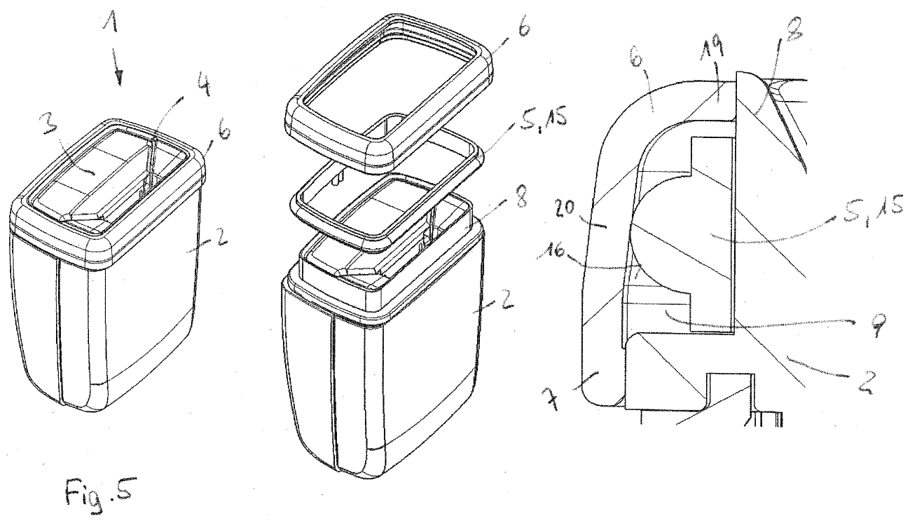

FIG. 5 shows a seat belt buckle according to the invention with a light source in the form of an annular light conductor according to a third embodiment; and

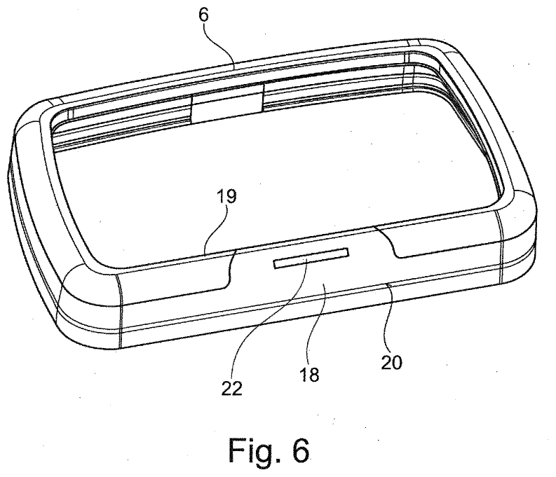

FIG. 6 shows a cover element with an information symbol.

In FIG. 1, an illuminated seat belt buckle 1 according to the invention can be seen with a housing 2, a push button 3 arranged on the end face, and an insertion slot 4 arranged adjacent to the latter for the insertion and locking of a latch plate (not shown) of a seat belt device. In the housing 2, a locking mechanism (not shown) is provided for locking the latch plate which can be released by actuating the push button 3 for ejecting the latch plate in the described manner.

On the end face of the housing 2, an annular section 8 is provided which projects from a base surface 10 of the housing 2 and which encloses the push button 3 and the insertion slot 4 of the seat belt buckle 1. The base region 10 of the housing 2 is also designed to be annular and extends over the entire circumference of the housing 2 on the radial outer side of the annular section 8. Furthermore, a cover element 6, which is also annular, is provided, which is fastened via a fastening attachment 7 to the outside of the housing 2 in the section forming the base surface 10. To fasten the cover element 6, it can be glued or welded, for example, to the fastening attachment 7 on the outside of the housing 2.

The cover element 6 extends from the fastening attachment 7 in a first section 20 extending in the direction of the end face of the housing and continues from the first section 20 via a curved section into a second section 19 which is directed on the end face of the housing 2 in the direction of the annular section 8. With the fastening attachment 7 the cover element 6 radially outwardly abuts the housing 2 and with the end face of the second section 19 the annular section 8, wherein the fastening attachment 7 continues or extends the first section 20 of the cover element 6. The cover element 6 therefore encloses an annular cavity 9 which is bordered toward the radial inside by the annular section 8 and toward the underside by the base region 10. An annular light source 5 is arranged on the base surface 10 of the cavity 9. Light sources 5 can be surface light sources, LED chains or even light guides with corresponding light-exit surfaces.

The cover element 6 is integrally made of a translucent material. Upon an activation of the light source 5, the cavity 9 is completely illuminated, wherein due to the integral, translucent design of the cover element 6 the light emerges to the outside through the first section 20, the second section 19 and the curved section of the cover element 6 arranged therebetween. The seat belt buckle 1 is therefore illuminated homogeneously in a ring shape over the entire outer surface of the first section 20, the second section 19 and the curved section of the cover element 6, wherein the push button 3 and the insertion slot 4 are arranged within the luminous ring. Since the cover element 6 with the fastening attachment 7 abuts the outside of the housing 2 and the second section 19 flat and, as far as possible and within the scope of the possible manufacturing accuracy, abuts the annular section 8 without a gap, the light emerges exclusively via the outer surface of the cover element 6 so that a visually high-quality illumination of the seat belt buckle 1 can be realized. In this regard, depending on the requirements of the customer, in order to increase the scattering of the light the radiation characteristics can be changed by deliberately roughening the cover element 6, for example by etching the surface or by a specific embossed surface structure on its radial outer side or also on its radial inner side. It is also conceivable to provide a partially transparent coating of the cover element 6 which allows the light to escape when the light source 5 is activated, but prevents a view through the cover element 6 when the light source 5 is deactivated. The cover element 6 has the first section 20 and the second section 19, wherein the first section 20 is arranged on the radial outer side of the seat belt buckle 1, and the second section 19 is arranged on the end face of the seat belt buckle 1. In this case, the cover element 6 can be deliberately designed differently in the region of the first section 20 and of the second section 19 in order to achieve a homogeneous appearance of the illuminated seat belt buckle 1, wherein the thicknesses of the two sections 19 and 20, the surface quality or the arrangement of locally opaque regions is available for this purpose.

In FIG. 2, a further developed embodiment of the embodiment in FIG. 1 can be seen. The fastening attachment 7 is formed here by a latching arm which latches into a groove 17 of the housing 2 in order to fasten the cover element 6. The latching arm and/or the groove 17 can be formed over the entire circumference of the housing 2 or the cover element 6 or only sectionally in the form of a plurality of latching arms and a plurality of spaced-apart grooves 17. Furthermore, the cover element 6 is deliberately provided with a section 18 in the region of the first section 20 in which additional logos of the customer or information symbols of another type can be provided.

In FIG. 3, a further development of the embodiment in FIG. 1 can be seen in which the cover element 6 can have different thicknesses in the region of the second section 19. Depending on the desired radiation characteristic, the cover element 6 can be designed thicker or thinner in the second section 19, wherein the cover element 6 remains unchanged in the region of the first section 20 and the fastening attachment 7. It is also conceivable to design the cover element 6 with different circumferential thicknesses in the region of the second section 19 so that the cover element 6 has different radiation characteristics along its circumference. The rigidity of the cover element 6 can thereby also be designed differently over the circumference. However, it is preferred to design the cover element 6 thicker in the region of the second section 19 than in the region of the first section 20.

In FIG. 4, a further development of the embodiment in FIG. 1 can be seen, in which the cover element 6 has an integrally formed light-conducting section 11. Otherwise, the cover element 6 can be designed to be in particular in the region of the fastening section 7 and the first section 20 according to the exemplary embodiment in FIG. 1. The light-conducting section 11 extends into the cavity 9 and has a light-entry surface 13 which is arranged parallel and opposite to a light-emitting surface 12 of the light source 5, forming a gap with a constant gap width.

The light-emitting surface 12 of the light source 5 is regarded as an idealized light-emitting surface which, when the light source 5 is designed with a plurality of LEDs, is regarded as the plane in which the LEDs are arranged. If the light source 5 is a surface light source, the light-emitting surface will be the surface of the surface light source. If the light source 5 is designed in the form of a light conductor, the light-emitting surface 12 will be the averaged plane of the light-exit surface of the light conductor.

The cover element 6 also has a gap 14 between the light conductor 11 and the first section 20 of the outer wall of the cover element 6, which gap makes it possible for the fastening section 7 to spring out radially outwards when the cover element 6 is fastened.

The light emitted by the light source 5 is then emitted via the light-emitting surface 12 and coupled into the light conductor via the oppositely arranged light-entry surface 13 of the light conductor 11. The light is then passed on in the light conductor 11 into the first section 20, into the second section 19 and into the curved section of the cover element 6 located therebetween and is emitted via these to the outside.

In FIG. 5, a further exemplary embodiment of the invention can be seen, in which the light source 5 is formed by a light conductor 15 abutting the side surface of the annular section 8. The light conductor 15 has a light-exit surface 16 which is opposite the first section 20 of the cover element 6 on the inside in the cavity 9. The light-exit surface 16 is partially circular in cross-section, in the present case semicircular, so that the light exits from the light conductor 15 via the light-emitting surface 16 not only in the direction of the first section 20 but also in the direction of the second section 19 of the cover element 6 and of the curved section of the cover element 6 arranged therebetween. The light conductor 15 is ring-shaped and has an inner surface corresponding to the outer surface of the annular section 8 so that its inner side lies flat against the outer side of the annular section 8. The cover element 6 can also be designed according to the exemplary embodiments in FIGS. 1 to 4.

In FIG. 6 the cover element 6 can be seen, in which a marking 22 is provided in the section 18. The marking 22 can be, for example, an information symbol with the information content that individualizes the seat belt buckle 1, a logo of a vehicle manufacturer or even a type designation of the vehicle. For this purpose, the cover element 6 can be formed by a black transparent material or have a correspondingly colored transparent cover layer. The marking can be lasered free or painted, for example, or applied by a pad printing process. For application of the marking 22, the section 18 can have a special shape, e.g. be flattened or have a certain profile, wherein the profile can correspond in shape to the marking 22 or can itself form the marking 22. The section 18 in which the marking 22 is provided can be part of the first section 20, part of the second section 19 or extend over both sections 20 and 19.

1. An illuminated seat belt buckle for a seat belt device of a motor vehicle, comprising
a housing,
a push button which is displaceable in the housing,
an insertion slot for the insertion of a belt tongue which can be locked in the seat belt buckle, and
at least one annular light source comprising the insertion slot and the push button, and
a cover element which covers the annular light source towards the radial outer face and towards the end face of the seat belt buckle,
wherein
the cover element is formed integrally from a translucent material.

2. The illuminated seat belt buckle according to claim 1, wherein
the cover element has an integrally formed fastening attachment, by means of which it is fastened to the housing of the seat belt buckle.

3. The illuminated seat belt buckle according to claim 2, wherein
that the fastening attachment has at least one latching hook by means of which it is latched to an undercut of the housing.

4. The illuminated seat belt buckle according to claim 1, wherein
the housing has a closed annular portion comprising the insertion slot (4) and the push button, which portion delimits an annular cavity towards the radial inner face, wherein
the annular cavity is delimited by the cover element towards the radial outer face and towards the end face of the seat belt buckle, and
the light source is arranged in the annular cavity.

5. The illuminated seat belt buckle according to claim 4, wherein
the cover element in the region of the end face of the seat belt buckle rests against the annular portion of the housing.

6. The illuminated seat belt buckle according to either claim 4, wherein
the annular portion projects from a base surface of the housing, and
the cover element radially outwardly abuts a portion of the housing forming the base surface.

7. The illuminated seat belt buckle according to claim 6, wherein
the light source is arranged on the base surface radially on the outside with respect to the annular portion of the housing.

8. The illuminated seat belt buckle according to claim 7, wherein
the cover element has an integrally formed light-conducting portion which has a light-entry surface arranged parallel and opposite to a light-emitting surface of the light source.

9. The illuminated seat belt buckle according to claim 8, wherein
a gap is provided between the integrally formed light-conducting portion and a radially outer edge of the cover element.

10. The illuminated seat belt buckle according to claim 6, wherein
the light source is formed by an annular light conductor which rests against the radial outer face of the annular portion and has a light exit surface.

11. The illuminated seat belt buckle according to claim 10, wherein
the light conductor is partially circular in cross section, and
the light exits from the light conductor both towards the radial outer face of the seat belt buckle and towards the end face of the seat belt buckle.

12. The illuminated seat belt buckle according to claim 1, wherein
the cover element is arranged without contact with the light source.

13. The illuminated seat belt buckle according to claim 1, wherein
the cover element has a first portion which extends in the direction of an end face of the seat belt buckle, and
the cover element has a second portion which extends on the end face of the seat belt buckle in the direction of the push button and the insertion slot.

14. The illuminated seat belt buckle according to claim 13, wherein
the second portion has a greater thickness than the first portion.

15. The illuminated seat belt buckle according to claim 13, wherein
a marking, preferably an information symbol, is provided on the first portion (20) and/or the second portion.

16. The illuminated seat belt buckle according to claim 13, wherein
the cover element has a different surface finish on the outer face of the first portion than on the outer face of the second portion.

17. The illuminated seat belt buckle according to claim 13, wherein
the cover element in the region of the first portion is locally opaque due to a coating, printing or surface treatment.
